(19) United States
(12) Patent Application Publication
(10) Pub. No.: US 2010/0002351 A1
(43) Pub. Date: Jan. 7, 2010

(54) METHOD AND APPARATUS FOR CONTROLLING A DC LOAD

(75) Inventor: Karapet Ablabutyan, Glendale, CA (US)

Correspondence Address: Myers Andras Sherman LLP, 19900 MacArthur Blvd., Suite 1150, Irvine, CA, 92612, US

(73) Assignee: Maxon Industries, Inc., Santa Fe Springs, CA (US)

(21) Appl. No.: 12/167,995

(22) Filed: Jul. 3, 2008

(51) Int. Cl. H01H 47/00

(52) U.S. Cl. 361/211

(57) ABSTRACT

A method and apparatus is provided for controlling power to a DC load ON and OFF. The apparatus has a first FET bank, a second FET bank, connected in series with a first FET bank, and a controller. The controller is configured for detecting a operational failure of at least one of the FET banks, and turning at least on of the FET banks OFF in response, thereby turning power to the DC load OFF. The controller may also detect a operational failure of one of the FET banks, and turn the other FET bank OFF in response, thereby turning power to the DC load OFF.

### BACKGROUND OF THE INVENTION

1. Field of the Invention

The present invention relates generally to power control and in particular to controlling DC loads.

2. Background Information

A solenoid typically comprises an electrical conductive coil of wire wound around a ferromagnetic core such as a solid iron core. When electrical current is applied to the coil, a resulting magnetic field is focused by the core, thereby providing an electromagnet function. Often solenoids are used to turn ON/OFF high current devices based on such electromagnet function, such as magnetically attracting (engaging) a contact for closing an electrical circuit when the solenoid coil is energized.

Conventional solenoids, however, are problematic in a first respect because such solenoids require high current (several amperes) to engage. Such solenoids are also problematic in a second respect because the solenoid may mechanically “stick” to the switch contact (keeping the switch ON), even when the coil is de-energized. In situations where it would be catastrophic for the solenoid to fail in the ON position, an approach involves using two solenoids in series so that if one solenoid sticks the other can still function and turn OFF the solenoid output. However, when two solenoids are used, twice as much current is required to turn both ON, and there is no indication to an operator if one of the solenoids sticks.

### SUMMARY OF THE INVENTION

The invention provides a method and apparatus for controlling power to a DC load ON and OFF. One embodiment involves a relay apparatus including a first FET bank, a second FET bank connected in series with a first FET bank, and a controller. The controller is configured for detecting a operational failure of at least one of the FET banks, and turning at least on of the FET banks OFF in response, thereby turning power to the DC load OFF. The controller may also detect a operational failure of one of the FET banks, and turn the other FET bank OFF in response, thereby turning power to the DC load OFF.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the invention, as well as a preferred mode of use, reference should be made to the following detailed description read in conjunction with the accompanying drawings, in which:

FIG. 1 shows a functional block diagram of a relay apparatus according to an embodiment of the invention.

FIG. 2 shows a more detailed functional block diagram of architecture a relay apparatus according to an embodiment of the invention.

FIG. 3 shows an example schematic of an implementation of the relay architecture of FIG. 2, according to an embodiment of the invention.

### DESCRIPTION OF THE PREFERRED EMBODIMENTS

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

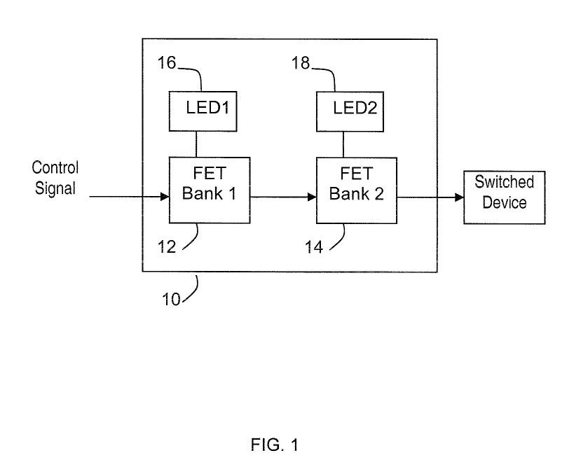

The invention provides a direct current (DC) relay for controlling DC devices (loads) of up to e.g. 100 amperes (amps). Referring to FIG. 1, in one embodiment such a relay 10 utilizes two independently controlled switches including two banks 12, 14, of metal-oxide field-effect transistors (FETs), in series. There are two banks of FET banks in series; each bank of FETs comprises one or more FETs in parallel. Increasing the number of FETs or the size of FETs increases the current capabilities of the device.

Using two FET banks prevents the relay output from staying ON in the event of a single FET bank failure, because the other FET bank can function to turn the rely output OFF. The DC relay 10 only requires a few milliamps of power for operation. The relay 10 further includes indicators, such as light emitting diodes (LEDs) 16, 18, for indicating each shorted or open FET over varying temperature or over current conditions.

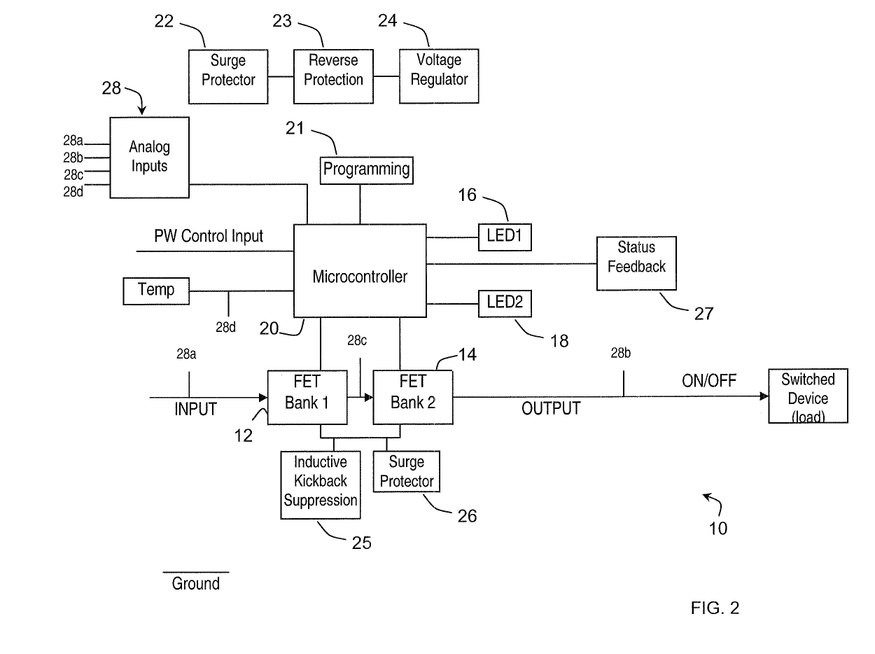

FIG. 2 shows further details of the relay 10, according an example implementation. The relay 10 includes said FET banks 12, 14, and LEDs 16, 18. Each FET bank includes one or more FETs connected in series. The relay 10 further includes a microcontroller (e.g., microprocessor) 20 that functions to control the internal operation of the FET banks and providing status information. The functions of the microcontroller 20 can be programmed using a programming module 21.

The INPUT for the relay 10 provides Power In (e.g., 7 to 18 volts). The OUTPUT provides Power Out for the switched device. The INPUT comes from a DC power source such as a battery; the OUTPUT goes to a load such as a motor.

The relay 10 includes a surge protector 22, a reverse protection function 23 and a voltage divider 24. The relay 10 further includes inducting kickback suppression module (e.g., diode) 25 and surge protector 26. If the relay 10 is used to power a load with an inductive element, then when the OUTPUT is turned off, the inductive element causes a negative voltage spike. The suppression module 25 suppresses negative spikes. The surge protector 26 suppresses high voltage spikes that may be present on the OUTPUT.

The relay 10 further includes a status feedback (FB) function 27 which is at e.g. 5V when the OUTPUT is ON, and at 0V when the OUTPUT is OFF. The FB 27 comprises a digital output that may be used to provide a feedback signal to indicate if the relay is operating. In one example, the FB goes high if the OUTPUT is on.

The relay 10 further includes analog inputs 28. In this example there are four analog inputs 28a, 28b, 28c and 28d, to the microcontroller 20, three of which read voltage and one reads temperature. The three that read voltage (28a, 28b, 28c) are connected to the INPUT, the OUTPUT, and the connection between the two banks of FET banks. The one that reads temperature (28d) connects to a temperature sensor that converts temperature to voltage.

A ground back plate for a printed circuit board implementation of the relay 10, provides electrical contact to ground.

A PW Control input (e.g., 12V) turns on the OUTPUT, open or 0V turns OFF the OUTPUT.

In one example operation, based on the status of the FED banks as monitored by the microcontroller 20, the microcontroller 20 provides the following status information using the LED 16 (e.g., Green LED) and LED 18 (e.g., Red LED).
Green LED on—OUTPUT is ON.
Green LED flashing fast—INPUT Voltage is above 16.5V (Fast is 5 flashes per second).
Green LED flashing slowly—Voltage is below 8.0V (Slow is 1 flash per second).
Red LED flashing fast—Over current. By taking the voltage difference across the two FET banks, the current that is passing through the relay to the load is approximated.
Red LED flashing slowly—Over temperature (over 100 C.).
Red LED 3 short flashes—Shorted FET, indicating one of the FET banks has malfunctioned.
Red LED 2 short flashes—Open FET, indicating an FET bank is open. FETs fail in one of two ways, open or shorted. An open FET will not turn ON and a shorted FET will not turn OFF.

The microcontroller 20 further manages the operation of the DC relay 10 as follows. When the DC relay 10 is first powered on, both LEDs turn on for 500 ms, and then turn back off. The DC relay 10 then goes into power down mode to minimize power consumption. Applying 12V to the PW Control input wakes up the relay 10, wherein the microcontroller 20 the INPUT (i.e., voltage at the input of the first FET bank), and also reads the voltage at the output of the first FET bank (i.e., voltage at the input of the second FET bank). The microcontroller 20 also reads the OUTPUT voltage (i.e., output voltage of the second FET bank). The microcontroller 20 may also read the temperature (via an internal temperature sensor Temp).

While the PW Control is ON, if at any time the INPUT voltage drops below 8.0 V or greater than 16.5 V, or if the temperature goes above 100 C., or if the current exceeds about 100 amps, then the micro controller 20 turns both FET banks OFF and flashes the LEDs to indicate an error condition. The temperature between the two banks of FETs is measured with a temperature sensor that is read by the microcontroller 20. If one of the banks of FET banks has failed (either open or shorted) then the error condition is indicated (i.e., the error is a failed FET). If a bank of FETs is open the relay no longer functions. If a bank of FETs is shorted then the relay turns off that FET bank to prevent the other FET bank from failing. As such, the relay prevents the load from being “stuck” ON. With two banks of FETs in series, if one of the FET banks short out then the other FET bank can still be turned OFF, thus turning OFF the output to the load.

If such an error condition is not detected, then the microcontroller 20 turns ON FET bank at a time and verifies that the FET banks are not shorted or opened. If the microcontroller 20 detects an open or shorted FET bank, then the microcontroller turns that FET bank off and flashes the LEDs as indicated above.

To verify that the FET banks are not shorted or open, the microcontroller 20 first checks the voltage at the output of the first FET bank (i.e., FET Bank 1). If that voltage is present, then the microcontroller indicates a shorted FET (i.e., first FET bank has shorted). If no voltage is present at the output of the first FET bank, then the microcontroller 20 turns ON the first FET bank and then verifies that the voltage at the output of the first FET bank is present (e.g., turns ON or goes above 0V). If that voltage is still not present, then the microcontroller 20 turns the first FET bank back OFF, and indicates an open FET bank via the LEDs.

If the first FET bank operates properly however, then the microcontroller 20 performs the same operations for the second FET bank (i.e., FET Bank 2), as the microcontroller 20 attempts to turn ON the second FET bank.

If the microcontroller 20 can turn either one of the FET banks ON based on the above process, then the relay 10 is operational. The redundant FET banks allow reliable control a DC load (switched device) of e.g. up to 100 amps. With the FET banks in series, a serious short condition still allows the microcontroller 20 to shut off (turn OFF the OUTPUT to power down the load). Further, the relay 10 can change state (ON/OFF) with using a few milliamps of current and the LEDs indicate error conditions. The relay 10 also does a self-check of the FET banks at startup (described above) to ensure there are no error conditions. If there are error conditions, the relay 10 indicates such using the LEDs and will not turn either FET bank ON.

When the PW Control is released or goes to 0V the PUTPUT should turn OFF. PW is an input to the relay and it is set high to turn ON the OUTPUT, and is set low to turn off the OUTPUT. When the PW Control is released or goes to 0V, then the microcontroller 20 turns off both FET banks and the LEDs, and powers down.

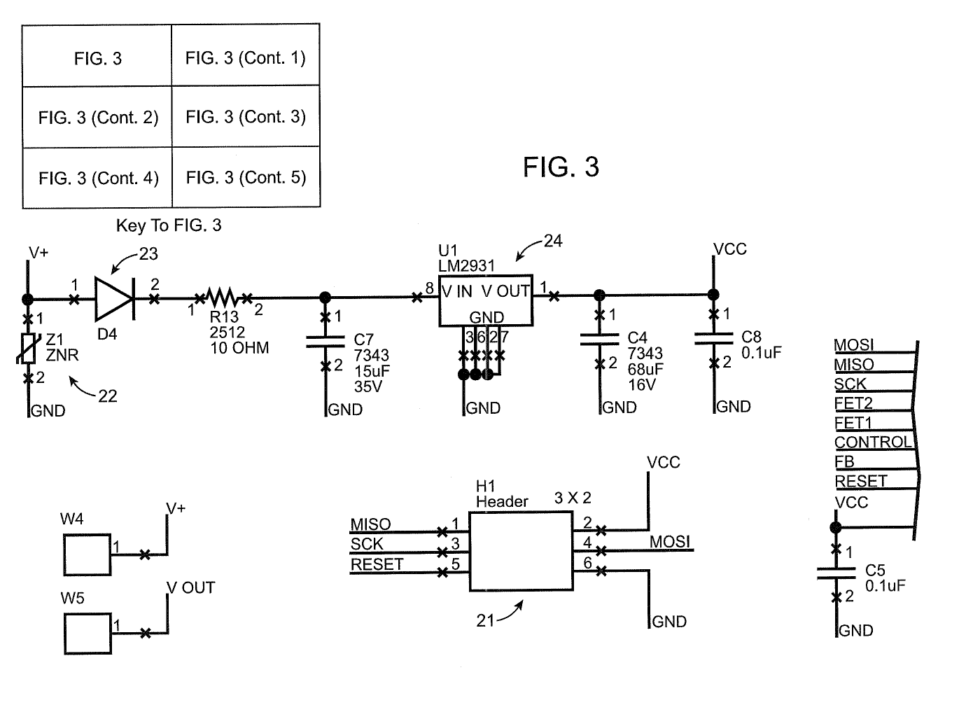

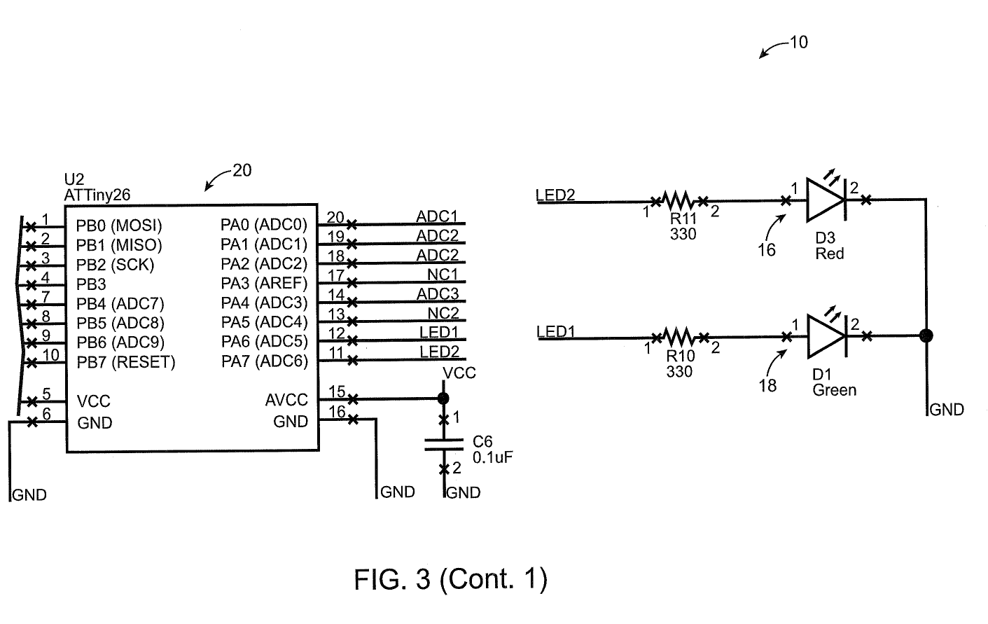

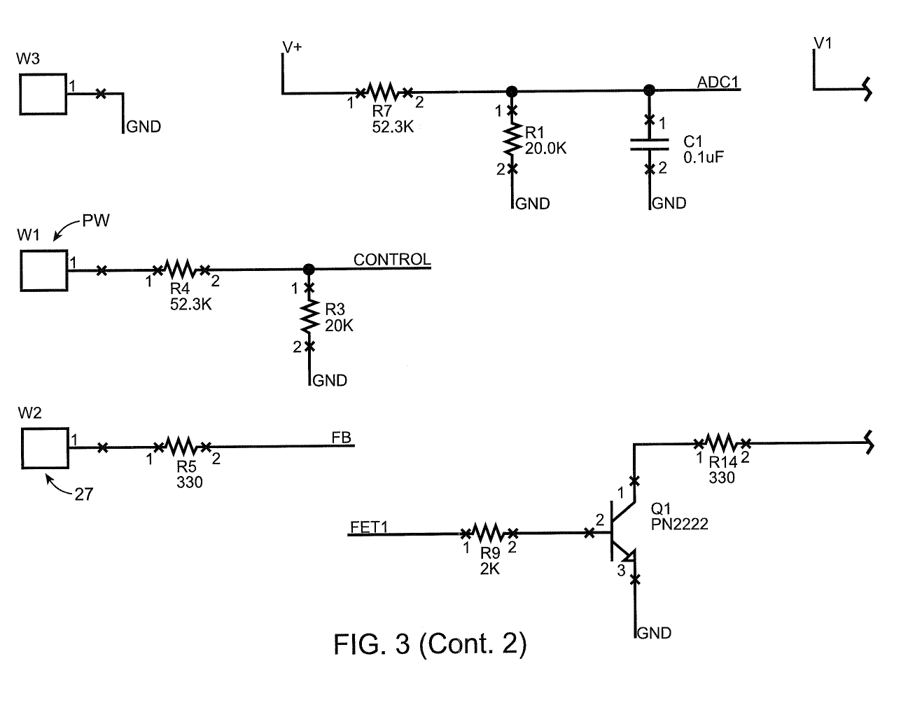

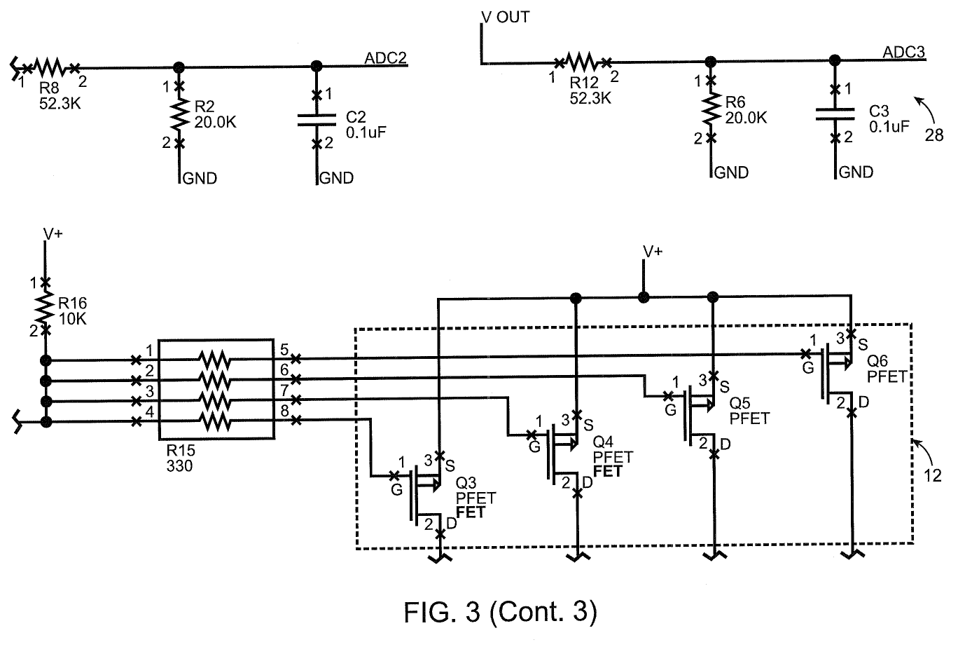

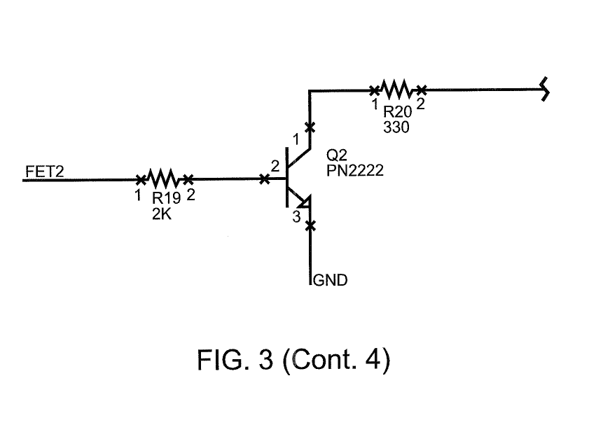

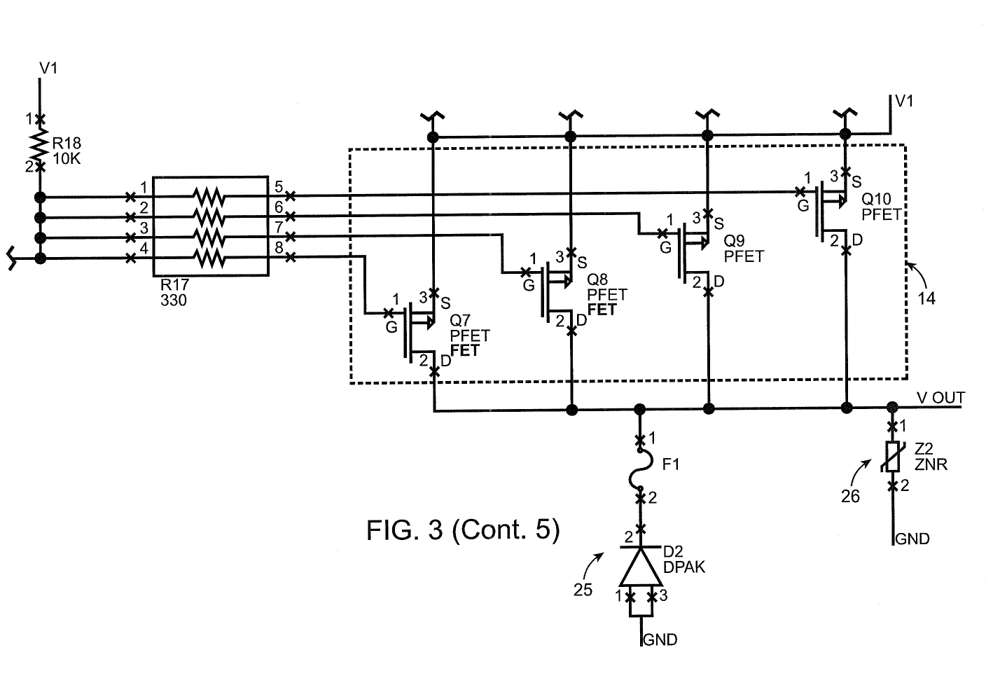

FIG. 3 shows a schematic of an example implementation of the functional architecture of the relay 10 in FIG. 2. The input power goes to the first bank of FETs 12 and also to the reverse protection diode 23 (which is only reverse protection for the electronics). The surge suppressor 22 clips any voltage spikes that may be present on the INPUT power to prevent a surge from causing damage to the FETs or the other electronics. Note that F1 opens if the relay is connected in reverse to power so that high current will not flow through the FETs and the inductive kickback suppression diode 25. Voltage regulator 24 provides a regulated voltage for the microcontroller and associated electronics.

The relay can detect high and low voltage, and preferably only operates in predefined ranges. The relay limits the current to protect the load (e.g., prevents overload if more than 100 amps seen). The relay turns off upon detecting and high temperatures, protects the FETs. The relay provides feedback to an operator to let the operator know when a FET is inoperative.

The relay can be used in conjunction with various loads, and in one example can be used for controlling a wheelchair lift electrical pump motor.

As is known to those skilled in the art, the aforementioned example embodiments described above, according to the present invention, can be implemented in many ways, such as program instructions for execution by a processor, as software modules, as computer program product on computer readable media, as logic circuits, as silicon wafers, as integrated circuits, as application specific integrated circuits, as firmware, etc. Though the present invention has been described with reference to certain versions thereof; however, other versions are possible. Therefore, the spirit and scope of the appended claims should not be limited to the description of the preferred versions contained herein.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. A relay apparatus for controlling power to a DC load ON and OFF, comprising:
a first FET bank;
a second FET bank, connected in series with a first FET bank; and
a controller configured for detecting a operational failure of at least one of the FET banks, and turning at least on of the FET banks OFF in response, thereby turning power to the DC load OFF.

2. The relay apparatus of claim 1 wherein the controller configured for detecting a operational failure of one of the FET banks, and turning the other FET bank OFF in response, thereby turning power to the DC load OFF.

3. The apparatus of claim 1 wherein the controller is further configured for detecting high and low voltage thresholds, and operating within the thresholds.

4. The apparatus of claim 1 wherein the controller is further configured for limiting current to the load.

5. The apparatus of claim 1 wherein the controller is further configured for turning OFF upon detecting temperatures above a threshold.

6. The apparatus of claim 1 wherein the controller is further configured for relay providing feedback on the operations status of the FET banks.
